(19) United States
(12) Patent Application Publication
(10) Pub. No.: US 2014/0129225 A1
(43) Pub. Date: May 8, 2014

(54) FILTERING SOME PORTIONS OF A MULTIMEDIA STREAM

(71) Applicant: Praveen S. Nair, Bangalore (IN)

(72) Inventor: Praveen S. Nair, Bangalore (IN)

(21) Appl. No.: 13/671,443

(22) Filed: Nov. 7, 2012

(51) Int. Cl. G10L 15/22

(52) U.S. Cl. CPC G10L 15/22
USPC 704/251; 704/E15.04

(57) ABSTRACT

A computing platform may comprise a receiver, which may identify inappropriate words in the original audio portion of a multimedia stream. The receiver may allow a user to store the inappropriate words in a memory and then compare the words in the original audio stream with the inappropriate words stored in the memory. If there is a match then such words may be filtered or blanked off from the original audio portion to generate a modified audio portion. The modified audio portion and the video portion may be synchronized to generate a synchronized multimedia stream, which may be void of inappropriate words.

### BACKGROUND

Multimedia content received over television channels, internet, several buses, and such other channels may include content unsuitable for a class of viewers (children, elders, a complete family watching a program together, for example). For example, there may be organizations (such as censor boards) in various countries to rate the movies based on the theme and content. The ratings (such as ‘A’ for Adult movies in India and PG/R rating in the US) may merely indicate the suitability for viewing without any control on the content being displayed. Also, the other type of content such as documentaries, news, serials, shows, videos and such other content may not even be rated. It make is difficult to exercise parental control or similar kind of restrictions on such content.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an environment 100, which may support filtering some portions of a multimedia stream in accordance with one embodiment.

FIG. 2 illustrates a computing platform 200, which may be used in a client device to support filtering some portions of a multimedia stream in accordance with one embodiment.

FIG. 3 illustrates a block diagram of a receiver 300, which may support filtering some portions of a multimedia stream in accordance with one embodiment.

FIG. 4 is a flow-chart, which illustrates an operation of the receiver 300, which may support filtering some portions of a multimedia stream in accordance with one embodiment.

FIG. 5 is a computer system, which may support filtering some portions of a multimedia stream according to one embodiment.

FIG. 6 is a wireless mobile device, which may support filtering some portions of a multimedia stream according to one embodiment.

### DETAILED DESCRIPTION

The following description describes embodiments of a technique to filter some portions of a multimedia stream. In the following description, numerous specific details such as logic implementations, resource partitioning, or sharing, or duplication implementations, types and interrelationships of system components, and logic partitioning or integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device).

For example, a machine-readable medium may include read only memory (ROM); random access memory (RAM); magnetic disk storage media; optical storage media; flash memory devices; electrical, optical, acoustical or other similar signals. Further, firmware, software, routines, and instructions may be described herein as performing certain actions. However, it should be appreciated that such descriptions are merely for convenience and that such actions in fact result from computing devices, processors, controllers, and other devices executing the firmware, software, routines, and instructions.

The multimedia content received on a client device may include audio, video, supplementary and other such streams. These audio and video streams may include content (“inappropriate content”), which may not be appropriate to be viewed by some class of viewers such as children and elderly people. In one embodiment, the client device may include a receiver to receive the multimedia content. In one embodiment, the receiver may include a comparison logic to compare phrases (or words) in an original audio portion (or stream) with a set of phrases (or words) stored in a memory (or database). In one embodiment, the receiver may include a filter logic to generate a modified audio portion based on filtering (or blanking off or overwrite matching words) one or more matching words in the original audio stream if there exist phrases in the original audio stream, which may match one or more phrases of the set of phrases. In one embodiment, the receiver may generate a synchronized multimedia stream based on synchronizing the modified audio stream with the original video stream. In one embodiment, content displayed on a display device may be based on the synchronized multimedia stream. In one embodiment, such an approach may allow parental control to be exercised to filter out the not so appropriate phrases or words from the original audio portion.

In one embodiment, the client device may support a user interface, which may be used by a user of the client device to store phrases that they may prefer to blank out in the content displayed. In one embodiment, the user may add new words or choose from an already available list of words, which may be displayed in a pop-window, for example, while the user attempts to store (or populate the databases). In one embodiment, the user may be provided with an authentication mechanism (such as password) to allow the user to authenticate himself (or herself) before using the user interface to store the phrases.

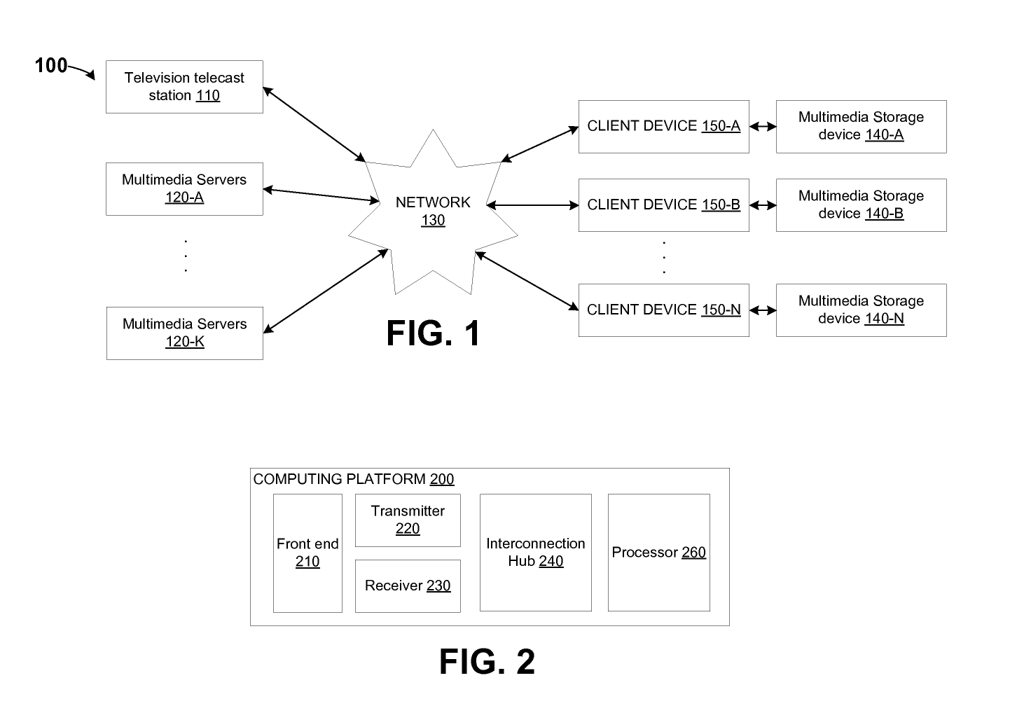

An embodiment of a computing environment 100, which may support filtering of multimedia content, is illustrated in FIG. 1. In one embodiment, the computing environment 100 may include source devices such as a television telecast station 110, one or more multi-media servers 120-A to 120-K, and multimedia storage devices 140, and consumption devices such as one or more client devices 150-A to 150-N. In one embodiment, the source and the consumption devices may be coupled to each other through a network 130. In one embodiment, the multi-media storage devices 140-A to 140-N may be, respectively, coupled to the one or more client devices 150-A to 150-N. In one embodiment, the television telecast station 110 may generate multimedia content and transmit the multimedia content over the network 150 and the client devices 150 may receive the multimedia content. Similarly, the multimedia content may be stored in multimedia servers 120, which may be accessed by the client devices 150. In one embodiment, the multimedia servers 120 may be coupled to client devices 120 through an internet, intranet, or a local network 130. In one embodiment, the client device 150 may access multimedia content from the multimedia storage device 140, which may include external hard disk memory, thumb drives, multimedia disks and such other storage devices.

In one embodiment, the network 130 may comprise one or more network devices such as a switch or a router, which may receive the messages or packets or frames, process the frames, and send the frames to an appropriate network device provisioned in a path to the destination system. The network 130 may enable transfer of frame between one or more of the consumption devices and the source devices. The network devices of the network 130 may be configured to support various protocols such as TCP/IP.

An embodiment of a computing platform 200, which may be used in the client device 150 to support filtering of multimedia content, is illustrated in FIG. 2. In one embodiment, the platform 200 may comprise a front end 210, a transmitter 220, a receiver 230, interconnection hub 240, and a processor 260. In one embodiment, the front end 210 may include wired and wireless interface components such as antennas, radio frequency components, amplifiers, and noise reduction blocks, switches, for example. In one embodiment, the front end 210 may include components to transfer outbound data from the transmitter to a wired or wireless medium and to receive inward data from the medium and provide the inward data to the receiver 230.

In one embodiment, the transmitter 220 may receive one or more data frames from the processor 260 through an interconnection hub 240 and perform modulation and other such operations before transmitting the one or more data frames. In one embodiment, the processor 260 may generate the one or more data frames based on the applications supported by the processor 260. In one embodiment, the interconnection hub 240 may couple the processor 260 to other portions such as the transmitter 220 and the receiver 230 of the platform 200.

In one embodiment, the receiver 230 may receive a multimedia stream and filter inappropriate phrases in an original audio portion of the multimedia stream. In one embodiment, the receiver 230 may include a memory, which may be used by the user (for example, parents) to store a set of phrases. In one embodiment, the receiver 230 may compare the phrases in the original audio portion of the multimedia stream with a set of phrases stored in the memory. In one embodiment, the receiver 230 may generate a modified audio portion by filtering out (or blank-off or replace such matching words with an appropriate phrase) phrases in the original audio stream that may match with at least one of the set of phrases. In one embodiment, the modified multimedia stream may thus include phrases in the original audio portion except the phrases, which match with at least one of the set of phrases. In one embodiment, the receiver 230 may synchronize the modified audio portion with the video portion or any other such components of the multimedia stream before sending the synchronized multimedia stream onward for displaying the multimedia content.

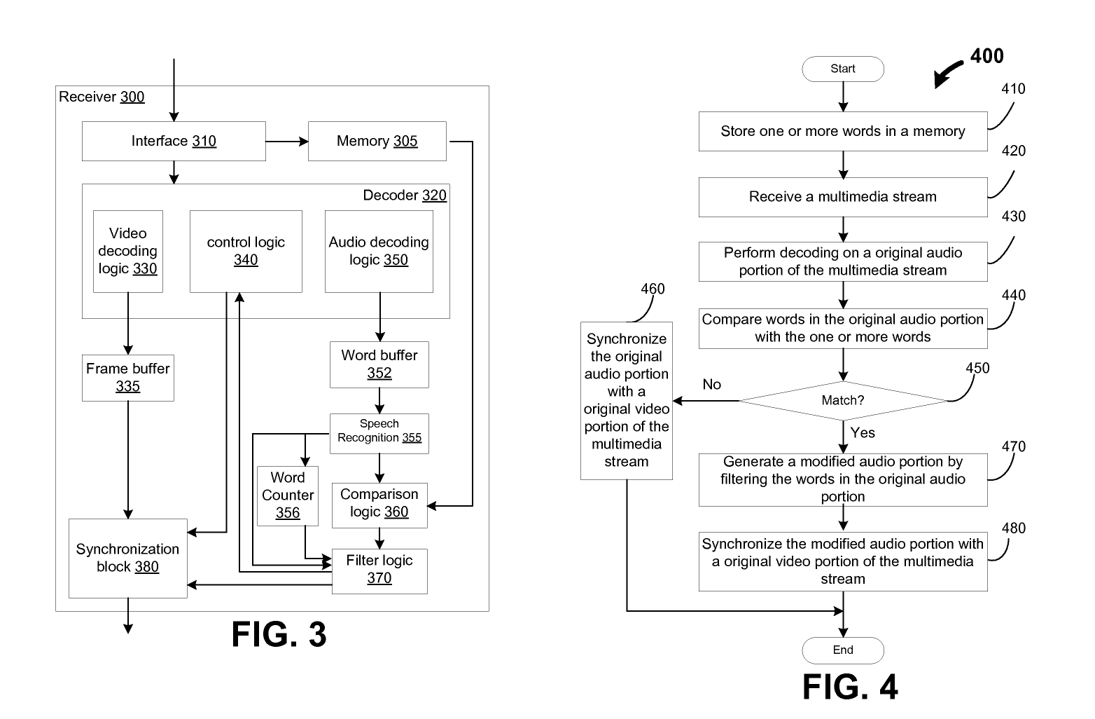

An embodiment of a receiver, which may support filtering of some portions of a multimedia stream, is illustrated in FIG. 3. In one embodiment, the receiver 300 may include an interface 310, a memory 305, a decoder 320, a frame buffer 335, a word buffer 352, a speech recognition block 355, a word counter 356, a comparison logic 360, a filter logic 370, and a synchronization block 380.

In one embodiment, the interface 310 may receive a multimedia stream and provide the audio portion, video portion, sub-title portion, and other such portions to the decoder 320. In one embodiment, the interface 310 may provide physical, electrical, and protocol interfaces between the receiver 300 and a front end block. In one embodiment, the interface 310 may support one or more user interfaces (UI) to allow a user to provide phrases, which may be filtered out from the multimedia stream. In one embodiment, the interface 310 may store such phrases in the memory 305.

In one embodiment, the decoder 320 may include a video decoding logic 330, a control logic 340, an audio decoding logic 350. In one embodiment, the video decoding logic 330 may receive video portion of the multimedia stream and decode the video portion. In one embodiment, the video decoding logic 330 may include video codecs based on H.264, MPEG, or HVC standards. In one embodiment, the video decoding logic 330 may support USB video decoding, PCI and PCI-e video decoding and such other similar decoding techniques. In one embodiment, the video decoding logic 330 may store the video frames in the frame buffer 335.

In one embodiment, the audio decoding logic 350 may support one or more audio decoding techniques such as a maximum likelihood decoding, maximum distance decoding, syndrome decoding, Viterbi decoding and such other decoding. In one embodiment, the audio decoding logic 350 may decode the original audio portion in the multimedia stream and then store the phrases or words in a word buffer 352.

In one embodiment, the speech recognition logic 355 may retrieve the phrases or words stored in the word buffer 352 and recognize the words. In one embodiment, the speech recognition block 355 may perform speech recognition using techniques such as segmentation analysis, principal component analysis, linear discriminate analysis, independent component analysis, linear predictive coding, filter bank analysis, Mel-frequency scale or cepstrum analysis and such other analysis to identify the words. In one embodiment, the words (or phrases) so recognized (in the original audio portion of the multimedia stream) may be provided to a comparison logic 360. In one embodiment, the speech recognition logic 355 may update the word counter 356 after recognizing each word. In one embodiment, the speech recognition logic 355 may increment the counter for each recognized word.

In one embodiment, the comparison logic 360 may compare the words in the original audio portion with the words stored in the memory 305. In one embodiment, the comparison logic 360 may generate and send a first signal to the filter logic 370 if there exists at least one word (in the memory 305), which may match with the word recognized by the speech recognition logic 355. In one embodiment, the comparison logic 255 may generate and send a second signal to the filter logic 360 if the word recognized by the speech recognition logic 355 does not match with any word (or phrase) of the set of words stored in the memory 305.

In one embodiment, the filter logic 360 may identify the position of the matching word in the original audio portion based on the count registered in the word counter 356. In one embodiment, the filter logic 360 may replace such words with a blank, or any other standard word or sound or any other such content. In one embodiment, the original audio portion with inappropriate words replaced by a blank or any other such content may be referred to as a modified audio portion (or modified audio stream). In one embodiment, the filter logic 360 may send a ready signal to the control logic 340 in response to generating the modified audio portion. In one embodiment, the filter logic 360 may send the modified audio portion to the synchronization block 380.

In one embodiment, the control logic 340 may generate a start_synchronize signal in response to receiving the ready signal and may send the start_synchronize signal to the synchronization block 380. In one embodiment, the synchronization block 380 may synchronize the modified audio stream with the video stream or any other stream such as the sub-title and captions stream before providing the synchronized multimedia stream for display. In one embodiment, the synchronization block 380 may support synchronization techniques such as Audio-video time difference based technique, audio-video neighbor based technique, feature rank sum based technique, and such other synchronization techniques.

An embodiment of an operation of the receiver 300, which may support filtering of some portions of a multimedia stream, is illustrated in flow-chart of FIG. 4. In block 410, the receiver 300 may store one or more words in a memory such as the memory 305. In one embodiment, the receiver 300 may support user interfaces to allow the user to provide words to be removed or blanked out from the audio portion of the multimedia stream.

In block 420, the receiver 300 may receive a multimedia stream. In one embodiment, the receiver 300 may receive the multimedia stream, which may include audio, video, and captions (or subtitle) portions.

In block 430, the receiver 300 may perform decoding of the multimedia stream including an original audio portion of the multimedia stream. In one embodiment, the receiver 300 may perform speech recognition to recognize the words or phrases as described above.

In block 440, the receiver 300 may compare the phrases in the original audio portion with the one or more words stored in the memory and control passes to block 450. In block 450, the receiver 300 may determine whether a match exist between the words in the original audio portion and the one or more words stored in the memory and control passes to block 460 if a match is not found and to block 470 if a match is found.

In block 460, the receiver 300 may synchronize the original audio portion with the original video portion in the multimedia stream and then pass the synchronized multimedia stream onward to a display device or any other device.

In block 470, the receiver 300 may generate a modified audio portion by filtering out the phrases, which match with the one or more words in the memory. In block 480, the receiver 300 may synchronize the modified audio portion with the original video portion and the synchronized multimedia stream may then be forwarded to a display device or any other device.

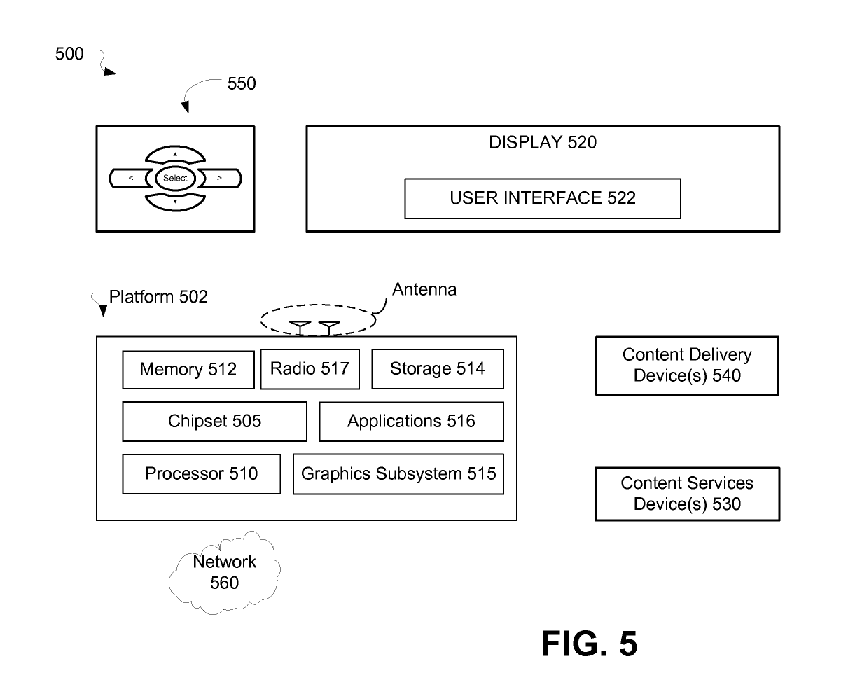

FIG. 5 illustrates an embodiment of a system 500. In embodiments, system 500 may be a media system although system 500 is not limited to this context. For example, system 500 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 500 comprises a platform 502 (similar to the platform 200 described above) coupled to a display 520. Platform 502 may receive content from a content device such as content services device(s) 530 or content delivery device(s) 540 or other similar content sources. A navigation controller 550 comprising one or more navigation features may be used to interact with, for example, platform 502 and/or display 520. Each of these components is described in more detail below.

In embodiments, platform 502 may comprise any combination of a chipset 505, processor 510, memory 512, storage 514, graphics subsystem 515, applications 516, and/or radio 517. In one embodiment, the radio 517 may include a transceiver comprising a transmitter and a receiver such as the receiver 300 described above. Chipset 505 may provide intercommunication among processor 510, memory 512, storage 514, graphics subsystem 515, applications 516 and/or radio 517. For example, chipset 505 may include a storage adapter (not depicted) capable of providing intercommunication with storage 514.

Processor 510 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 510 may comprise dual-core processor(s), dual-core mobile processor(s), and so forth.

Memory 512 may be implemented as a volatile memory device such as, but not limited to, a Random Access Memory (RAM), Dynamic Random Access Memory (DRAM), or Static RAM (SRAM).

Storage 514 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 514 may comprise technology to increase the storage performance enhanced protection for valuable digital media when multiple hard drives are included, for example.

Graphics subsystem 515 may perform processing of images such as still or video for display. Graphics subsystem 515 may be a graphics processing unit (GPU) or a visual processing unit (VPU), for example. An analog or digital interface may be used to communicatively couple graphics subsystem 515 and display 520. For example, the interface may be any of a High-Definition Multimedia Interface, DisplayPort, wireless HDMI, and/or wireless HD compliant techniques. Graphics subsystem 515 could be integrated into processor 510 or chipset 505. Graphics subsystem 515 could be a stand-alone card communicatively coupled to chipset 505.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 518 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 517 may operate in accordance with one or more applicable standards in any version.

In embodiments, display 520 may comprise any television type monitor or display. Display 520 may comprise, for example, a computer display screen, touch screen display, video monitor, television-like device, and/or a television. Display 520 may be digital and/or analog. In embodiments, display 920 may be a holographic display. Also, display 520 may be a transparent surface that may receive a visual projection. Such projections may convey various forms of information, images, and/or objects. For example, such projections may be a visual overlay for a mobile augmented reality (MAR) application. Under the control of one or more software applications 516, platform 502 may display user interface 522 on display 520.

In embodiments, content services device(s) 530 may be hosted by any national, international and/or independent service and thus accessible to platform 502 via the Internet, for example. In one embodiment, the content services device(s) 530 may be hosted in a cloud. Content services device(s) 530 may be coupled to platform 502 and/or to display 520. Platform 502 and/or content services device(s) 530 may be coupled to a network 560 to communicate (e.g., send and/or receive) media information to and from network 560. Content delivery device(s) 540 also may be coupled to platform 502 and/or to display 520.

In embodiments, content services device(s) 530 may comprise a cable television box, personal computer, network, telephone, Internet enabled devices or appliance capable of delivering digital information and/or content, and any other similar device capable of unidirectionally or bidirectionally communicating content between content providers and platform 502 and/display 520, via network 560 or directly. It will be appreciated that the content may be communicated unidirectionally and/or bidirectionally to and from any one of the components in system 500 and a content provider via network 560. Examples of content may include any media information including, for example, video, music, medical and gaming information, and so forth.

Content services device(s) 530 receives content such as cable television programming including media information, digital information, and/or other content. Examples of content providers may include any cable or satellite television or radio or Internet content providers. The provided examples are not meant to limit embodiments of the invention.

In embodiments, platform 502 may receive control signals from navigation controller 950 having one or more navigation features. The navigation features of controller 550 may be used to interact with user interface 522, for example. In embodiments, navigation controller 550 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 550 may be echoed on a display by movements of a pointer, cursor, focus ring, or other visual indicators displayed on the display. For example, under the control of software applications 516, the navigation features located on navigation controller 550 may be mapped to virtual navigation features displayed on user interface 522, for example. In embodiments, controller 550 may not be a separate component but integrated into platform 502 and/or display 520. Embodiments, however, are not limited to the elements or in the context shown or described herein.

In embodiments, drivers (not shown) may comprise technology to enable users to instantly turn on and off platform 502 like a television with the touch of a button after initial boot-up, when enabled, for example. Program logic may allow platform 502 to stream content to media adaptors or other content services device(s) 530 or content delivery device(s) 540 when the platform is turned “off.” In addition, chipset 505 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 500 may be integrated. For example, platform 502 and content services device(s) 530 may be integrated, or platform 502 and content delivery device(s) 540 may be integrated, or platform 502, content services device(s) 530, and content delivery device(s) 540 may be integrated, for example. In various embodiments, platform 502 and display 520 may be an integrated unit. Display 520 and content service device(s) 530 may be integrated, or display 520 and content delivery device(s) 540 may be integrated, for example. These examples are not meant to limit the invention.

In various embodiments, system 500 may be implemented as a wireless system, a wired system, or a combination of both. When implemented as a wireless system, system 500 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 500 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 502 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

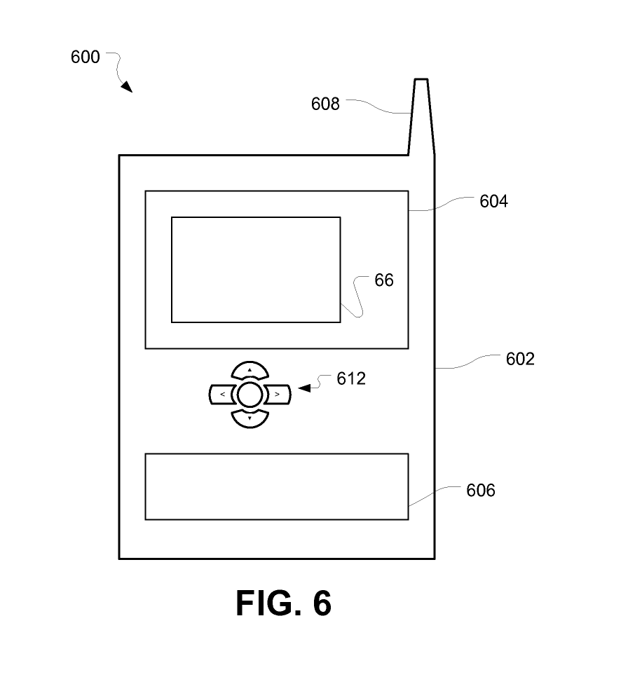

As described above, system 500 may be embodied in varying physical styles or form factors. FIG. 6 illustrates embodiments of a small form factor device 600 in which system 600 may be embodied. In embodiments, for example, device 600 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 6, device 600 may comprise a housing 602, a display 604, an input/output (I/O) device 606, and an antenna 608. Device 600 also may comprise navigation features 612. Display 604 may comprise any suitable display unit for displaying information appropriate for a mobile computing device. I/O device 606 may comprise any suitable I/O device for entering information into a mobile computing device. Examples for I/O device 606 may include an alphanumeric keyboard, a numeric keypad, a touch pad, input keys, buttons, switches, rocker switches, microphones, speakers, voice recognition device and software, and so forth. Information also may be entered into device 600 by way of microphone. Such information may be digitized by a voice recognition device. The embodiments are not limited in this context. The device 600, in one embodiment, may include foldable integrated display panels, which may be unfolded to have a bigger display area.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A receiver, comprising:
an interface to receive a multimedia stream including an original audio portion and a video portion,
a memory to store one or more words, wherein the one or more words are inappropriate to heard by a class of viewers,
a speech recognition logic to recognize words in the original audio portion,
a comparison logic to compare the words in the original audio portion with the one or more words stored in the memory,
a filter logic to generate a modified audio portion if at least one word in the original audio portion matches with the one or more words in the memory, wherein the at least one word in the original audio portion that matches with the one or more words in the memory is replaced with a blank, and
a synchronization block to generate a synchronized signal based on synchronizing the modified audio portion and the video portion.

2. The receiver of claim 1 further comprises a word counter, wherein the speech recognition logic is to increment the word counter for each recognized word in the original audio portion.

3. The receiver of claim 1, wherein the comparison logic is to generate a first signal if there is the at least one word in the original audio portion which matches with the one or more words in the memory.

4. The receiver of claim 3, wherein the comparison logic is to generate a second signal if there is no word in the original audio portion which matches with the one or more words in the memory.

5. The receiver of claim 2, wherein the filter logic is to identify the position of the at least one word in the original audio portion based on a count registered in the word counter.

6. The receiver of claim 5, wherein the filter logic is to generate a third signal to indicate that modified audio portion is ready.

7. The receiver of claim 6 further comprises a control logic, wherein the control logic is to generate a fourth signal to initiate synchronization of the modified audio portion and the video portion.

8. The receiver of claim 7, wherein the synchronization logic is to generate the synchronized signal using the modified audio portion and the video portion in response to receiving the fourth signal.

9. The receiver of claim 8, wherein the synchronization logic is to generate the synchronized signal using the original audio portion and the video portion in response to the comparison logic generating the second signal.

10. A method in a receiver, comprising:
receiving a multimedia stream including a original audio portion and a video portion,
storing one or more words in a memory, wherein the one or more words are inappropriate to heard by children,
recognizing words in the original audio portion using a speech recognition technique,
comparing the words in the original audio portion with the one or more words stored in the memory,
generating a modified audio portion if at least one word in the original audio portion matches with the one or more words in the memory, wherein the at least one word in the original audio portion that matches with the one or more words in the memory is replaced with a blank, and
generating a synchronized signal based on synchronizing the modified audio portion and the video portion.

11. The method of claim 10 further comprises incrementing a word counter for each recognized word in the original audio portion.

12. The method of claim 10 comprises generating a first signal if there is the at least one word in the original audio portion which matches with the one or more words in the memory.

13. The method of claim 12 comprises generating a second signal if there is no word in the original audio portion which matches with the one or more words in the memory.

14. The method of claim 11 comprises identifying a position of the at least one word in the original audio portion based on a count registered in the word counter.

15. The method of claim 14 comprises generating a third signal to indicate that modified audio portion is ready.

16. The method of claim 15 further comprises generating a fourth signal to initiate synchronization of the modified audio portion and the video portion.

17. The method of claim 16 comprises generating the synchronized signal using the modified audio portion and the video portion in response to receiving the fourth signal.

18. The method of claim 17 comprises generating the synchronized signal using the original audio portion and the video portion in response to the comparison logic generating the second signal.

19. A computing system, comprising:
a platform,
a display, and
a plurality of content delivery devices and content services devices,
wherein the platform further comprises a processor, a graphics subsystem, a chipset, a memory, and a radio block,
wherein the radio block further comprises a receiver to,
receive a multimedia stream including a original audio portion and a video portion,
store one or more words, wherein the one or more words are inappropriate to heard by a class of viewers,
recognize words in the original audio portion,
compare the words in the original audio portion with the one or more words stored in the memory,
generate a modified audio portion if at least one word in the original audio portion matches with the one or more words in the memory, wherein the at least one word in the original audio portion that matches with the one or more words in the memory is replaced with a blank, and
generate a synchronized signal based on synchronizing the modified audio portion and the video portion.

20. The computing system of claim 19, wherein the receiver is track a count of the words recognized in the original audio portion.

21. The computing system of claim 19, wherein the receiver is to generate a first signal if there is the at least one word in the original audio portion which matches with the one or more words in the memory.

22. The computing system of claim 21, wherein the receiver is to generate a second signal if there is no word in the original audio portion which matches with the one or more words in the memory.

23. The computing system of claim 20, wherein the receiver is to identify the position of the at least one word in the original audio portion based on the count of words.

24. The computing system of claim 23, wherein the receiver is to generate a third signal to indicate that modified audio portion is ready.

25. The computing system of claim 24, wherein the receiver is to generate a fourth signal to initiate synchronization of the modified audio portion and the video portion.

26. The computing system of claim 25, wherein the receiver is to generate the synchronized signal using the modified audio portion and the video portion in response to receiving the fourth signal.

27. The computing system of claim 26, wherein the receiver is to generate the synchronized signal using the original audio portion and the video portion in response to the comparison logic generating the second signal.
